(19) United States
(12) Patent Application Publication
(10) Pub. No.: US 2007/0144170 A1
(43) Pub. Date: Jun. 28, 2007

(54) Compressor having integral EGR valve and mixer

(75) Inventor: Robert Charles Griffith, Chillicothe, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/313,777

(22) Filed: Dec. 22, 2005

(51) Int. Cl. F02D 23/00; F02B 33/44

(52) U.S. Cl. 60/600; 60/605.1; 60/605.2

(57) ABSTRACT

A compressor for a power system is disclosed. The compressor has a compressor wheel rotatable to compress a fluid, and a compressor housing at least partially enclosing the compressor wheel. The compressor housing has a first volute and a second volute. The first volute is configured to direct an exhaust gas radially inward to the compressor wheel. The second volute is configured to direct a mixture of the exhaust gas and air radially outward from the compressor wheel.

### TECHNICAL FIELD

The present disclosure relates generally to a compressor and, more particularly, to a compressor having an integral exhaust gas recirculation (EGR) valve and mixer.

### BACKGROUND

Internal combustion engines such as, for example, diesel engines, gasoline engines, or gaseous fuel-powered engines may be operated to generate a power output. In order to maximize the power generated by the engine, it may be equipped with a turbocharged air induction system. A turbocharged air induction system may include a turbocharger that compresses the air flowing into the engine to thereby force more air into a combustion chamber. The increased supply of air allows for increased fuelling, which may result in increased power. A turbocharged engine typically produces more power than a naturally aspirated engine.

It is common knowledge that internal combustion engines, including both turbocharged and naturally aspirated engines, produce a complex mixture of air pollutants during operation. The air pollutants are composed of solid particulate matter and gaseous compounds including nitrous oxides (NOx). Due to increased attention on the environment, exhaust emission standards have become more stringent and the amount of solid particulate matter and gaseous compounds emitted to the atmosphere from an engine is regulated depending on the type of engine, size of engine, and/or class of engine.

One method that has been implemented by engine manufacturers to comply with the regulation of these engine emissions has been to implement exhaust gas recirculation (EGR). EGR systems circulate the exhaust gas by-products back into the internal combustion engine via the turbocharger. The exhaust gas, which is redirected to the combustion chamber of the engine, reduces the concentration of oxygen therein, thereby lowering the maximum combustion temperature within the chamber. The lowered combustion temperature slows the chemical reaction of the combustion process, thereby decreasing the formation of NOx. In addition, the particulate matter entrained in the exhaust is burned upon reintroduction into the engine combustion chamber to further reduce the exhaust gas by-products.

When a turbocharged engine is fitted with an EGR system, packaging can become an issue. In particular, because of the number of components and duct work associated with the turbocharger, and because of the number of components and duct work associated with the EGR system, space within an engine compartment is quickly consumed. As a result, design flexibility may be limited, access to critical components of the engine may be hindered, and the compartment required to house the turbocharged, EGR-equipped engine can become too large for some applications.

One method implemented by engine manufacturers to accommodate the space requirements of a turbocharged, EGR-equipped engine is described in U.S. Pat. No. 6,324,847 (the '847 patent), issued to Pierpont on Dec. 4, 2001. In particular, the '847 patent describes a high pressure exhaust gas recirculation system having a turbocharger with an integrated EGR valve. In particular, an EGR outlet is provided within a flange in the volute of a turbine housing. A mating valve assembly extends from a mating flange with an elbow.

Although the integral turbocharger-EGR valve design of the '847 patent may reduce the foot print of a turbocharged, EGR-equipped engine (e.g., the space consumed by the engine) by integrating multiple components into a single common housing, it may only be applicable to a high pressure EGR system. In particular, a low pressure system that draws exhaust gas from a location downstream of the turbine may not benefit from an EGR valve located in the volute of the turbine. In addition, because the design of the '847 patent only integrates two components into a single housing, the amount of space reduced by the integration may be minimal.

The disclosed compressor is directed to overcoming one or more of the problems set forth above.

### SUMMARY OF THE INVENTION

In one aspect, the present disclosure is directed to a compressor. The compressor includes a compressor wheel rotatable to compress a fluid, and a compressor housing at least partially enclosing the compressor wheel. The compressor housing includes a first volute and a second volute. The first volute is configured to direct an exhaust gas radially inward to the compressor wheel. The second volute is configured to direct a mixture of the exhaust gas and air radially outward from the compressor wheel.

In another aspect, the present disclosure is directed to a method of operating a compressor. The method includes axially directing air to a compressor wheel, radially directing exhaust gas to the compressor wheel, and rotating the compressor wheel to compress a mixture of the air and exhaust gas. The method further includes radially discharging the compressed mixture.

In yet another aspect, the present disclosure is directed to another compressor. The compressor includes a compressor wheel rotatable to compress a fluid, a compressor housing at least partially enclosing the compressor wheel, and a valve element. The valve element is disposed within the compressor housing and is configured to regulate a flow of exhaust gas to the compressor wheel.

In yet another aspect, the present disclosure is directed to another method of operating a compressor. The method includes axially directing air to a compressor wheel, directing exhaust gas from a point downstream of a turbine to a regulating valve located within the compressor, and mixing the exhaust gas and air within the compressor. The method also includes compressing the mixture of air and exhaust gas, and radially discharging the compressed mixture.

### BRIEF DESCRIPTION OF THE DRAWINGS

FIG. 1 is a diagrammatic illustration of a power source having an exemplary disclosed fluid handling system;

FIG. 2 is a pictorial illustration of an exemplary disclosed compressor for the fluid handling system of FIG. 1; and

FIG. 3 is a cross-sectional illustration of an the exemplary disclosed compressor of FIG. 2.

### DETAILED DESCRIPTION

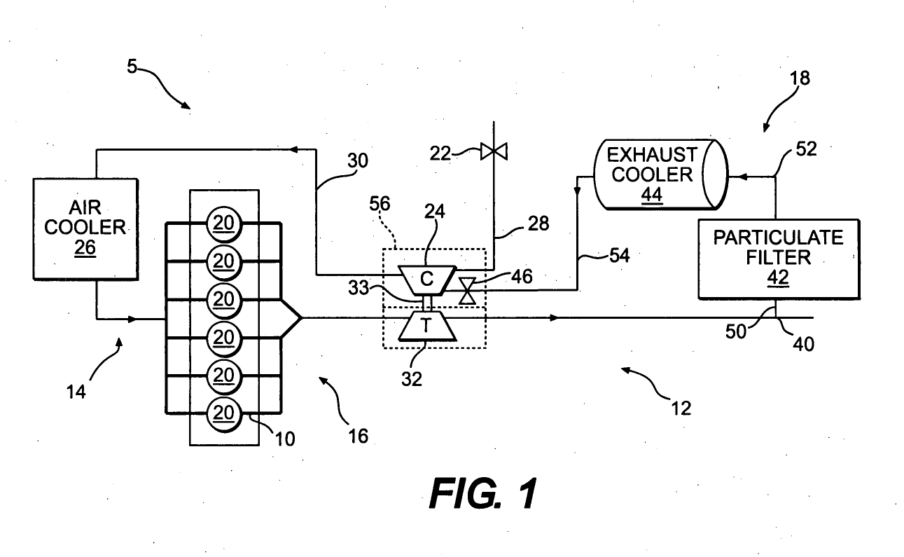

FIG. 1 illustrates a power system 5 having a power source 10 and an exemplary fluid handling system 12. Power source 10 may include an engine such as, for example, a diesel engine, a gasoline engine, a gaseous fuel-powered engine such as a natural gas engine, or any other type of combustion engine apparent to one skilled in the art. Power source 10 may alternatively include another source of power such, for example, a furnace. Fluid handling system 12 may include, an exhaust system 16, a recirculation system 18, and an air induction system 14.

Exhaust system 16 may include a means for directing exhaust flow out of power source 10. For example, exhaust system 16 may include one or more turbines 32 connected in a series or parallel relationship. It is contemplated that exhaust system 16 may include additional components such as, for example, particulate traps, NOx absorbers or other catalytic devices, attenuation devices, and other means for directing exhaust flow out of power source 10 that are known in the art.

Each turbine 32 may be connected to one or more compressor 24 of air induction system 14 by way of a common shaft 33 and configured to drive the connected compressor 24. In particular, as the hot exhaust gases exiting power source 10 expand against blades (not shown) of turbine 32, turbine 32 may rotate and drive the connected compressor 24. It is also contemplated that turbine 32 may be omitted and compressor 24 driven by power source 10 mechanically, hydraulically, electrically, or in any other manner known in the art, if desired.

Recirculation system 18 may include a means for redirecting a portion of the exhaust flow from power source 10 to air induction system 14. For example, recirculation system 18 may include an inlet port 40, a recirculation particulate filter 42, an exhaust cooler 44, and a recirculation valve 46. It is contemplated that recirculation system 18 may include additional or different components such as a catalyst, an electrostatic precipitation device, a shield gas system, one or more sensing elements, and other means for redirecting that are known in the art

Inlet port 40 may be connected to exhaust system 16 and configured to receive at least a portion of the exhaust flow from power source 10. Specifically, inlet port 40 may be disposed downstream of turbines 32 to receive low pressure exhaust gases from turbines 32. It is contemplated that inlet port 40 may alternatively be located upstream of turbines 32 for use in a high pressure recirculation application.

Recirculation particulate filter 42 may be connected to inlet port 40 via a fluid passageway 50 and configured to remove particulates from the portion of the exhaust flow directed through inlet port 40. Recirculation particulate filter 42 may include electrically conductive or non-conductive coarse mesh elements. It is contemplated that recirculation particulate filter 42 may include a catalyst for reducing an ignition temperature of the particulate matter trapped by recirculation particulate filter 42, a means for regenerating the particulate matter trapped by recirculation particulate filter 42, or both a catalyst and a means for regenerating. The means for regenerating may include, among other things, a fuel-powered burner, an electrically-resistive heater, an engine control strategy, or any other means for regenerating known in the art. It is contemplated that recirculation particulate filter 42 may be omitted, if desired.

Exhaust cooler 44 may be fluidly connected to recirculation particulate filter 42 via fluid passageway 52 and configured to cool the portion of exhaust gases flowing through inlet port 40. Exhaust cooler 44 may include a liquid-to-air heat exchanger, an air-to-air heat exchanger, or any other type of heat exchanger known in the art for cooling an exhaust flow. It is contemplated that exhaust cooler 44 may be omitted, if desired.

Recirculation valve 46 may be fluidly connected to exhaust cooler 44 via a fluid passageway 54 and configured to regulate the flow of exhaust through recirculation system 18. Recirculation valve 46 may embody a butterfly valve, a shutter valve, a diaphragm valve, a gate valve, or any other type of valve known in the art. Recirculation valve 46 may be solenoid-actuated, hydraulically-actuated, pneumatically-actuated, or actuated in any similar manner. Recirculation valve 46 may be in communication with a controller (not shown) and selectively actuated in response to one or more predetermined conditions.

Air induction system 14 may include a means for introducing charged air into a combustion chamber 20 of power source 10. For example air induction system 14 may include an induction valve 22, an air cooler 26, and one or more compressors 24. It is contemplated that additional components may be included within air induction system 14 such as, for example, additional valving, one or more air cleaners, one or more waste gates, a control system, and other means for introducing charged air into combustion chambers 20 that are known in the art.

Induction valve 22 may be fluidly connected to compressors 24 via a fluid passageway 28 and configured to regulate the flow of atmospheric air to power source 10. Induction valve 22 may embody a shutter valve, a butterfly valve, a diaphragm valve, a gate valve, or any other type of valve known in the art. Induction valve 22 may be solenoid-actuated, hydraulically-actuated, pneumatically-actuated, or actuated in any other manner. Induction valve 22 may be in communication with a controller (not shown) and selectively actuated in response to one or more predetermined conditions.

Air cooler 26 may embody an air-to-air heat exchanger or an air-to-liquid heat exchanger and be configured to facilitate the transfer of thermal energy to or from the air and exhaust gas mixture directed into power source 10. For example, air cooler 26 may include a shell and tube-type heat exchanger, a corrugated plate-type heat exchanger, a tube and fin-type heat exchanger, or any other type of heat exchanger known in the art. Air cooler 26 may be connected to power source 10 via a fluid passageway 30.

Compressor 24 may be configured to compress the air flowing into power source 10 to a predetermined pressure level. Compressors 24, if more than one is included within air induction system 14, may be disposed in a series or parallel relationship and fluidly connected to power source 10 via fluid passageway 30. Compressor 24 may include a fixed geometry compressor, a variable geometry compressor, or any other type of compressor known in the art.

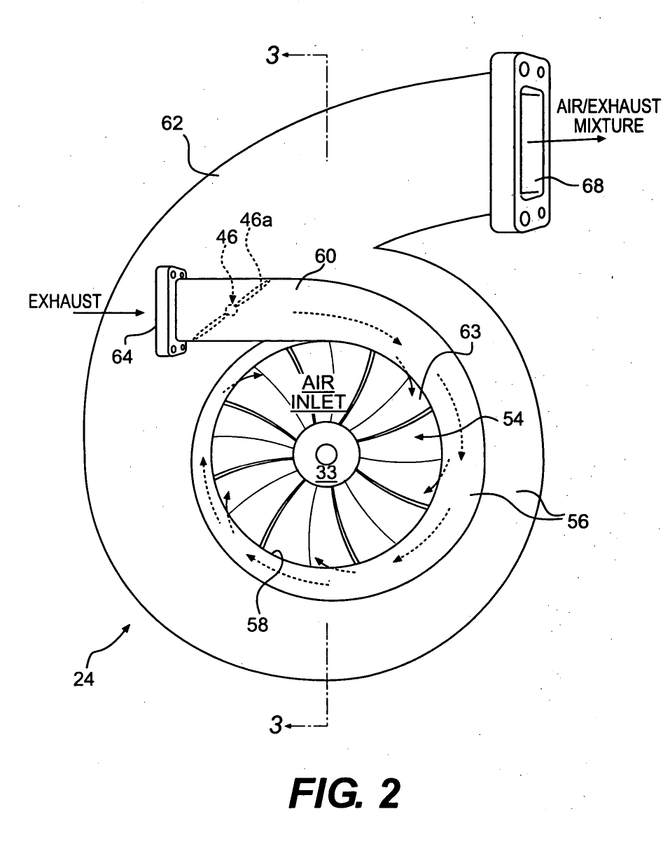

As illustrated in FIG. 2, compressor 24 be an assembly of different components. In particular, compressor 24 may include a common compressor housing 56 having a central axial bore 58, a first volute 60, and a second volute 62. Common compressor housing 56 may be a single integral component, fabricated, for example, through a casting process. A compressor wheel 55, operatively connected to turbine 32 by way of common shaft 33, may be disposed within central axial bore 58 and at least partially enclosed by common compressor housing 56. Central axial bore 58 may be configured to axially direct inlet air toward blades 63 of compressor wheel 55.

First volute 60 may fluidly connect turbine 32 with compressor wheel 55. Specifically, first volute 60 may have an inlet 64 configured to receive a flow of exhaust gas from downstream of turbine 32 via inlet port 40 and fluid passageways 50 and 52. In this manner, a portion of the exhaust gas from power source 10 may be recirculated through central axial bore 58 of common compressor housing 56 for mixing with inlet air.

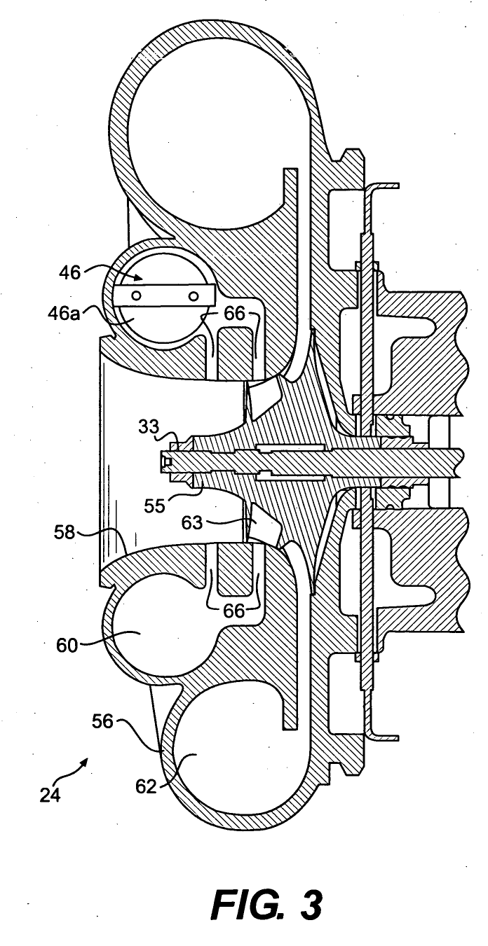

As illustrated within FIG. 3, first volute 60 may include a means for mixing exhaust gas with inlet air. The means for mixing may include, for example, a series of radial passageway 66, a mixing chamber (not shown), or other means known in the art for creating a substantially homogeneous mixture of exhaust gas and inlet air. Radial passageways 66 may extend from first volute 60 to central axial bore 58 at predetermined annular intervals. Although radial passageways 66 are illustrated as being disposed in pairs, it is contemplated that a single annular row of radial passageways 66 may alternatively be included. It is additionally contemplated that only a single radial passageway 66 or continuous channel may be implemented to direct exhaust gas from first volute 60 into central axial bore 58, if desired.

As also illustrated in FIG. 3, recirculation valve 46 may be housed at least partially within first volute 60. In particular, a valve element 46a may be disposed within the opening of first volute 60 to selectively restrict the flow of exhaust gas through first volute 60. For example, valve element 46a may be pivoted from a first position at which the flow through first volute 60 is substantially unrestricted, to a second position at which the flow through first volute 60 may be blocked. For the purposes of this disclosure, the term blocked is to be interpreted as at least partially restricted from air flow. It is also contemplated that valve element 46a, when in the second or blocked position, may be fully restricted from air flow. Valve element 46a may be movable to any position between the first and second positions to vary the restriction and resulting flow rate of exhaust gas through first volute 60.

Second volute 62 may be situated to direct the compressed mixture of exhaust gas and air from compressor wheel 55 to power source 10 via an outlet 68 and fluid passageway 30. As illustrated in both FIGS. 2 and 3, second volute 62 may have a greater diameter than first volute 60, and a twist direction opposite that of first volute 60. The greater volume may facilitate a greater flow of fluid, while the twist direction may correspond with the radially outward flow of the exhaust gas and air mixture away from compressor wheel 55.

### INDUSTRIAL APPLICABILITY

The disclosed fluid handling system may be implemented in any power system application where charged air induction and high or low pressure exhaust gas recirculation is utilized. The disclosed fluid handling system may reduce the space consumed by the induction and recirculation systems by integrating multiple components into a single housing. In addition, the disclosed fluid handling system may optimize operation of an associated power source by improving fluid delivery and mixing characteristics. The operation of fluid handling system 12 will now be explained.

Atmospheric air may be drawn into air induction system 14 by compressors 24 via induction valve 22, where it may be pressurized to a predetermined level before entering combustion chambers 20 of power source 10. Fuel may be mixed with the pressurized air before or after entering combustion chambers 20. This fuel-air mixture may then be combusted by power source 10 to produce mechanical work and an exhaust flow containing gaseous compounds and solid particulate matter. The exhaust flow may be directed from power source 10 to turbines 32 where the expansion of hot exhaust gasses may cause turbines 32 to rotate, thereby rotating connected compressors 24 and compressing the inlet air. After exiting turbines 32, the exhaust gas flow may be divided into two flows, including a first flow redirected to air induction system 14 and a second flow directed to the atmosphere.

As the first exhaust flow moves through inlet port 40 of recirculation system 18, it may be filtered by recirculation particulate filter 42 to remove particulate matter prior to communication with exhaust cooler 44. The particulate matter, when deposited on the mesh elements of recirculation particulate filter 42, may be passively and/or actively regenerated.

The flow of reduced-particulate exhaust may be cooled by exhaust cooler 44 to a predetermined temperature and then directed through recirculation valve 46 and radial passageways 66 for mixing within inlet air inside compressor 24. The flow of exhaust gas through compressor 24 and the resulting concentration of recirculated exhaust gas directed to power source 10 may be regulated by recirculation valve 46, in response to one or more input. The exhaust gas, which is directed to combustion chambers 20, may reduce the concentration of oxygen therein, which in turn lowers the maximum combustion temperature within power source 10. The lowered maximum combustion temperature may slow the chemical reaction of the combustion process, thereby decreasing the formation of nitrous oxides. In this manner, the gaseous pollution produced by power source 10 may be reduced.

Several advantages of fluid handling system 12 may be realized over the prior art. Specifically, because compressor 24, recirculation valve 46, and the means for mixing exhaust gas with inlet air (e.g., radial passageways 66) are integrated into single unit, the spatial requirements of power system 5 may be substantially reduced. In addition, the amount of ducting and associated cost typically required to interconnect the compressor, recirculation valve, and mixer may be minimized or even eliminated. Further, because the means for mixing is integrated with compressor 24, the turbulence created by the rotating/compressing action of compressor wheel 55 may promote the mixing of exhaust gas with inlet air. A more homogeneous mixture of exhaust gas and air may improve the operation of power source 10. Finally, because the recirculation valve is integrated into a volute associated with the compressor rather than the turbine, the disclosed compressor-recirculation valve-mixing means may be equally applicable in both low and high pressure EGR applications.

It will be apparent to those skilled in the art that various modifications and variations can be made to the disclosed exhaust control system. Other embodiments will be apparent to those skilled in the art from consideration of the specification and practice of the disclosed exhaust control system. It is intended that the specification and examples be considered as exemplary only, with a true scope being indicated by the following claims and their equivalents.

What is claimed is:

1. A compressor, comprising:
a compressor wheel rotatable to compress a fluid; and
a compressor housing at least partially enclosing the compressor wheel having:
a first volute configured to direct an exhaust gas radially inward to the compressor wheel; and
a second volute configured to direct a mixture of the exhaust gas and air radially outward from the compressor wheel.

2. The compressor of claim 1, wherein the compressor housing further includes:
a central axial bore housing the compressor wheel and being configured to direct a flow of air to the compressor wheel; and
a means for mixing the exhaust gas from the first volute with the flow of air in the central axial bore, before the mixture is directed radially outward via the second volute.

3. The compressor of claim 2, wherein the first volute, the second volute, and the central axial bore are fabricated from a single integral casting.

4. The compressor of claim 2, wherein the means for mixing includes a plurality of radial passageways connecting the first volute and the central axial bore.

5. The compressor of claim 1, further including a valve element disposed within the first volute.

6. The compressor of claim 5, wherein the valve element is configured to regulate the flow of exhaust gas through the compressor.

7. The compressor of claim 5, wherein the valve element is a butterfly valve element.

8. The compressor of claim 1, wherein the compressor is associated with a turbine, and the compressor further includes a passageway in fluid communication with the first volute and the turbine, the passageway being configured to direct the exhaust gas from downstream of the turbine to the second volute.

9. The compressor of claim 1, wherein the twist direction of the first volute is opposite the twist direction of the second volute.

10. A method of operating a compressor, comprising:
axially directing air to a compressor wheel;
radially directing exhaust gas to the compressor wheel;
rotating the compressor wheel to compress a mixture of the air and exhaust gas; and
radially discharging the compressed mixture.

11. The method of claim 10, further including mixing the air and exhaust gas.

12. The method of claim 11, wherein mixing includes radially directing the exhaust gas inward at a plurality of annular locations.

13. The method of claim 10, further including regulating the flow of exhaust gas directed to the compressor wheel.

14. The method of claim 13, wherein regulating includes moving a valve element located within the compressor.

15. The method of claim 10, wherein directing exhaust gas to the compressor wheel includes directing exhaust gas from downstream of a turbine.

16. A compressor, comprising:
a compressor wheel rotatable to compress a fluid;
a compressor housing at least partially enclosing the compressor wheel; and
a valve element disposed within the compressor housing and being configured to regulate a flow of exhaust gas to the compressor wheel.

17. The compressor of claim 16, wherein the compressor housing includes:
a central axial bore configured to direct air to the compressor wheel; and
a means for mixing the exhaust gas with the air in the central axial bore.

18. The compressor of claim 17, wherein the means for mixing includes a plurality of radial passageways connecting the valve element and the central axial bore.

19. The compressor of claim 16, wherein the compressor is associated with a turbine, and the compressor further includes a passageway in fluid communication with the valve element and the turbine, the passageway being configured to direct the exhaust gas from downstream of the turbine to the valve element.

20. A method of operating a compressor, comprising:
axially directing air to a compressor wheel;
directing exhaust gas from a point downstream of a turbine to a regulating valve located within the compressor;
mixing the exhaust gas and air within the compressor;
compressing the mixture of the air and exhaust gas; and
radially discharging the compressed mixture.

21. The method of claim 20, wherein mixing includes radially directing the exhaust gas inward to the compressor wheel at a plurality of annular locations.

22. A power system, comprising:
a power source configured to produce a power output and a flow of exhaust gas;
a turbine configured to receive the flow of exhaust gas and to rotate in response thereto; and
a compressor operatively driven by the turbine to compress a fluid, the compressor including:
a compressor wheel;
a compressor housing at least partially enclosing the compressor wheel, the compressor housing having:
a first volute configured to direct an exhaust gas from downstream of the turbine radially inward to the compressor wheel; and
a second volute configured to direct a mixture of the exhaust gas and air radially outward from the compressor wheel; and
a valve element disposed within the first volute and being configured to regulate a flow of the exhaust gas to the compressor wheel.

23. The power system of claim 22, wherein the compressor housing further includes:
a central axial bore housing the compressor wheel and being configured to direct a flow of air to the compressor wheel; and
a plurality of radial passageways connecting the first volute and the central axial bore, the plurality of radial passageways configured to mix the exhaust gas from the first volute with the flow of air in the central axial bore, before the mixture is directed radially outward via the second volute.

24. The power system of claim 22, wherein the first volute, the second volute, and the central axial bore are fabricated from a single integral casting.

25. The power system of claim 22, wherein the twist direction of the first volute is opposite the twist direction of the second volute.
